(19) United States
(12) Patent Application Publication
(10) Pub. No.: US 2014/0347476 A1
(43) Pub. Date: Nov. 27, 2014

(54) BRIDGE INSPECTING SYSTEM AND METHOD

(71) Applicant: National Taiwan University, Taipei (TW)

(72) Inventors: Shih-Chung Kang, Taipei (TW); Yi-Chu Chen, Taipei (TW); Chi-En Yang, Taipei (TW)

(73) Assignee: National Taiwan University, Taipei (TW)

(21) Appl. No.: 13/899,277

(22) Filed: May 21, 2013

(51) Int. Cl. H04N 7/18

(52) U.S. Cl. CPC H04N 7/18
USPC 348/143

(57) ABSTRACT

A system for inspecting a bridge is provided. The system includes an image sensor; a base immobily secured to the bridge and having an actuator disposed thereon; and a suspending medium having a first and a second ends, respectively connected with the image senor and the actuator so that the actuator actuates the image sensor to swing in one of a swing and a spinning mode through the suspending medium.

### FIELD

The present invention relates to a bridge inspecting system and an inspecting method based thereon. More particularly, it relates to a system and a method for inspecting a bridge's bottom.

### BACKGROUND

Bridge inspection is a critical task to ensure the safety and serviceability of bridges. Currently, most inspections still rely on a primitive manner: direct visual inspection. Inspectors are sent beneath the bridge either by means of an inspection vehicle or temporarily erected scaffolding. It not only is labor-intensive and time-consuming, but also poses threat on inspectors' safety. If access from below is possible, a cherry picker is a desirable way for inspection because this eliminates the need for traffic control on the bridge above. In many conditions, however, access from below is not available. For example, the bridge is crossing a river or a valley which is too deep for a cherry picker to reach from below. In such cases, a snooper or other types of under-deck platform can be used. However, the number of such special inspection vehicle is very limited due to its high price. Besides, to use such large equipment, traffic on the bridge will be disturbed; bridge structure and strength should be reviewed to ascertain safety. These facts lead to low efficiency when applying inspection vehicles in practice.

Furthermore, the accuracy of evaluation result varies according to the knowledge, experience and diligence of inspectors. The study indicates that “there are still significant shortcomings in the reliability and accuracy” of visual inspection. In summary, a safe, efficient and low price tool for bridge inspection is yet to be developed.

Thus, many investigators have introduced automation and robotic technologies for improving bridge inspection efficiency and safety. These researches can be divided into 3 groups in terms of bridge components: above-deck, under-deck and under water. Most components in the above-deck part are easy to reach, including pavement, barrier, sidewalk, and expansion joint. However, with the number of cable-stayed bridge increases, cable inspection becomes an essential and challenging task. The cable climbing robots are therefore developed for cable inspection. Automation of pavement inspection is another topic worth concern. Next, the under-water components, such as pier and foundation, are exposed to the risk of flood damage, and thus underwater robots were developed.

The under-deck part has drawn more inventors' attention than the other two parts. There are two main reasons: First, most structural components of a bridge are under-deck, including beam, pier, abutment, and bearing, etc. Second, as the purpose of a bridge is to cross obstacles such as rivers or valleys, under-deck components are usually difficult to reach. Improving the safety and efficiency of under-deck inspection become the most challenging task.

To ensure human workers' safety, heavy inspection vehicle or robot arm systems are possible solutions. Many inventions have been conducted on the solution of applying robot arms and vision systems for replacing human works, some with machine vision technique to enhance robot arm performance. Unfortunately, these approaches have a major drawback on flexibility. To reach deeper location beneath a bridge, the robot arm applied needs to be heavy in order to support its own weight, and thus needs a firm and solid support structure, e.g. a special designed vehicle with outriggers. As a result, the whole inspection system is heavy and tardy; inspection tasks can be done only on relatively larger bridges, and the equipment cost will be very high.

Moreover, the heavy inspection vehicles cannot meet the huge and growing demand of bridge inspection. As mentioned above, heavy inspection vehicles are slow in deployment and require large working space. In addition, they are not affordable to be widely adopted. These factors make heavy vehicles only suitable for large size bridges or bridges that have maintenance priority. According to an official statistic data, in terms of bridge length, middle to small bridge (less than 50 meters) are more than 80%, and in terms of bridge level, rural highways are over 50% in quantity. The above facts show that small or low level bridges make up a large proportion of all the bridges in Taiwan. These bridges are either too small or do not have priority for applying an inspection vehicle. In conclusion, another suitable inspection system rather than heavy inspection devices is needed for smaller bridges.

There is a need to solve the above deficiencies/issues.

### SUMMARY

Bridge inspection is a critical task to ensure the safety and serviceability of bridges. To improve bridge inspection efficiency and safety, automation methods like robot arms are introduced in this invention works; but they are unsuitable for middle to small bridges. Therefore, this invention focuses on developing a suitable inspection system for middle to small bridges.

Visual inspection is currently the major approach to evaluate the structural condition of a bridge. Many inventors developed special inspection vehicles and robot arms to increase the safety and reachability of inspection process. However, such heavy equipment is highly restricted in working space and is only suitable for large bridges. To solve this, it developed an innovative bridge inspection system using “dual-cable suspension mechanism”. This system utilizes cables as the sustaining mechanism, stretches beneath the bridge and captures images with digital vision devices. Unlike robot arms, the cable-based system can sustain much more weight than its own weight. It means the total weight is greatly reduced and the cost can be lowered than existing methods. As a result, the developed system is portable, simple and affordable, and can be easily applied on smaller yet large number bridges. It is made a prototype and conducted field experiments to test the feasibility of the proposed system. The experiment result shows that the developed system works effectively and efficiently. With further research, the proposed system and concept is expected to enhance overall bridge inspection efficiency.

In addition, in this invention it develops two modes to move camera into bridge bottom: 1.) resonance frequency swing mode, and 2.) merry-go-round spinning mode. Both modes use small energy to generate large swing amplitude, and large swing amplitude can send the inspection device to the deeper part beneath the bridge.

In accordance with one aspect of the present disclosure, it is provided that a system for inspecting a bridge includes an image sensor, a base immobily secured to the bridge and having an actuator disposed thereon, and a suspending medium having a first and a second ends, respectively connected with the image senor and the actuator so that the actuator actuates the image sensor to motion in one of a swing mode and a spinning mode through the suspending medium.

In accordance with another aspect of the present disclosure, it is provided that a system for inspecting a bridge includes a mobile base, an image sensor, and a first suspending medium and a second suspending medium, each of which has a first and a second ends respectively connected with the mobile base and the image sensor.

In accordance with another aspect of the present disclosure, it is provided that a method for inspecting a bridge includes steps of providing a base and an image sensor, and providing a first suspending medium having a first and a second ends respectively connected with the image sensor and the base so as to swing the image sensor.

The present disclosure may best be understood through the following descriptions with reference to the accompanying drawings, in which:

### BRIEF DESCRIPTION OF THE DRAWINGS

FIG. 1 is a schematic diagram illustrating a patterned first hard mask layer for the semiconductor structure fabricated in accordance with the present disclosure.

FIG. 2 is a schematic diagram illustrating vias etched into the first dielectric layer for the semiconductor structure fabricated in accordance with the present disclosure.

FIG. 3 is a schematic diagram illustrating an intermediate sacrificial layer covering over the vias and the first dielectric layer for the semiconductor structure fabricated in accordance with the present disclosure.

FIG. 4 is a schematic diagram illustrating a patterned second hard mask layer for the semiconductor structure fabricated in accordance with the present disclosure.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments described herein are capable of operation in other orientations than described or illustrated herein.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments, various features are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

In the description provided herein, numerous specific details are set forth. However, it is understood that embodiments may be practiced without these specific details. In other instances, well-known methods, structures and techniques have not been shown in detail in order not to obscure an understanding of this description.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

### First Embodiment

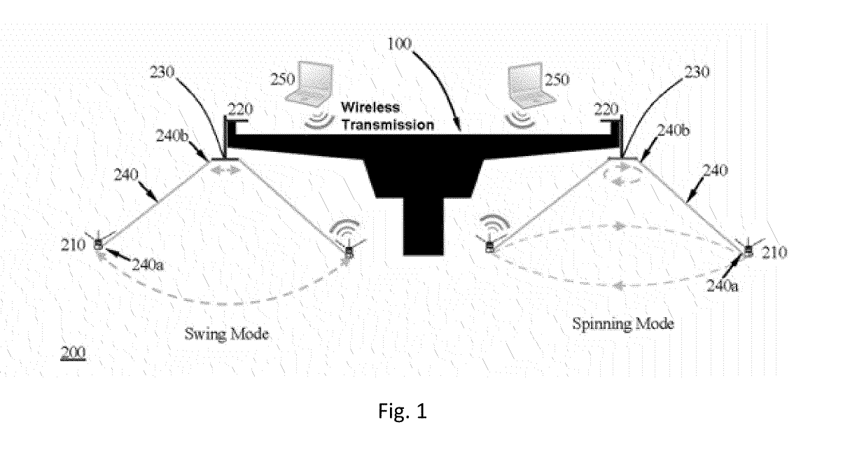

FIG. 1 is a schematic diagram which illustrates a first embodiment for the bridge inspection system in accordance with the present invention. The bridge inspection system 200 includes an image sensor 210, a base 220 and an actuator 230. The base 220 is immobily secured to the bridge 100 and the actuator 230 is disposed thereon. In the bridge inspection system 200, there is further a suspending medium 240 with a first end 240a and a second end 240b between the image senor 210 and the actuator 230, and respectively connected with the image senor 210 and the actuator 230, so that the actuator 230 actuates the image sensor 210 to swing in one of a resonance mode and a spinning mode through the suspending medium 240. The system 200 further has an information processing device 250 processing a digital data obtained and transmitted from the image sensor 210. The image sensor 210 is in wireless communication with the information processing device 250.

In the swing mode, which is also referred to as the “resonance frequency swing mode”, the actuator 230 is set to create small cyclic reciprocating motion to the end 240b of the suspending medium 240. Engineers can adjust the actuator 230 to make the swing cycle match to the frequency of the length of the suspending medium 240. Once the cycles are matched, the swing amplitude will gradually increase. Therefore, with small power motor, the inspection system 200 can create large swing amplitude. The large amplitude can send the image sensor 210 to the deeper location beneath the bridge 100. Because the suspending medium 240 is preferably longer than 3 meters, the system swinging cycle would be long; in other words, the image sensor 210 will not swing too fast. Bridge inspectors can adjust the length of the suspending medium 240 and motor speed to achieve suitable amplitude to better inspect the bottom side beneath the bridge 100.

In the spinning mode, which is also referred to as the “merry-go-round spinning mode”, the suspending medium 240 is attached to a small length rod arm driven by the actuator 230. Engineers can adjust the spinning speed to obtain different amplitude of the camera. Higher speed would lead to larger amplitude, and vice versa. By adjusting the length of the suspending medium 240 and spinning frequency, bridge inspectors can achieve suitable amplitude to better inspect the bottom side beneath the bridge 100.

Typically, the “resonance frequency swing mode” can achieve larger inspection area. The “merry-go-round spinning mode” needs considerably large horizontal space for spinning and thus the cable length is limited. Next, the “merry-go-round spinning mode” can provide better camera stability, i.e. one can make camera always looks up without attach another servo or motor. The “resonance frequency swing mode” needs to attach additional servos to adjust the direction of the digital camera. It is still a better way to use additional servo to adjust camera direction by remote control in both modes. The camera moves faster in merry-go-round spinning mode, and therefore the camera needs shorter exposure time. In both these two modes, the fishing line is preferably utilized to act as the suspending medium 240 and as the support mechanism, since the fishing line only has tension force so it can carry heavy objects in an efficient way.

The invention is aimed to develop a lightweight bridge inspection device and operation methodologies for replacement of current methods. It developed a prototype system of the proposed method. The system hardware platform contains ultrasonic distance sensors, digital camera and servo. The servo can move 180 degree and adjust the camera to face suitable direction. The system uses one laptop as a computational platform. Therefore, the control signal and camera image are centralize in the laptop with wireless transmission.

It developed two modes to move camera into bridge bottom: 1.) resonance frequency swing mode, and 2.) merry-go-round spinning mode. Both modes use small energy to generate large swing amplitude, and large swing amplitude can send the inspection device to the deeper part beneath the bridge.

This invention is still at the beginning stage. The quality of bridge inspection image still needs improvement. It generates the swing motion of the inspection platform manually. In the near future, it will be developed a suitable mechanism to swing the platform automatically. After the support frame of the platform is improved, it will implement the two proposed operation methods. The improved bridge inspection device should be less than 2 kilogram and can be easily deployed and controlled by only 2 inspectors. With the use of this lightweight cable based bridge inspection system, it is believed that bridge inspection can be more efficient, low-cost and flexible in the future.

### Second Embodiment

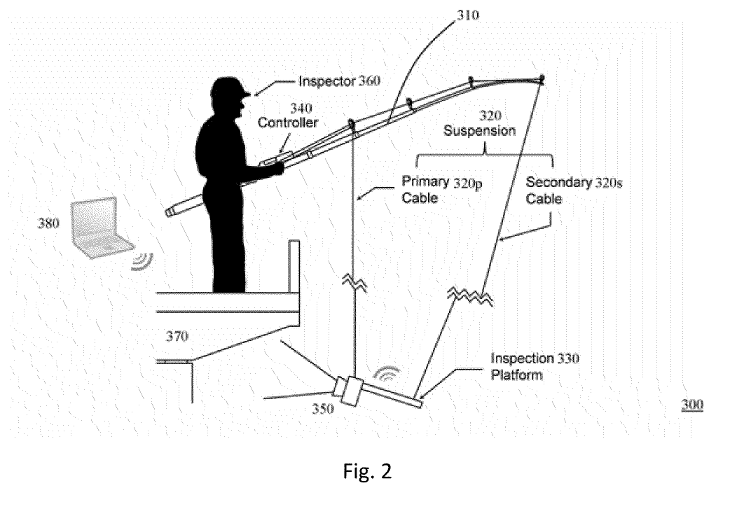

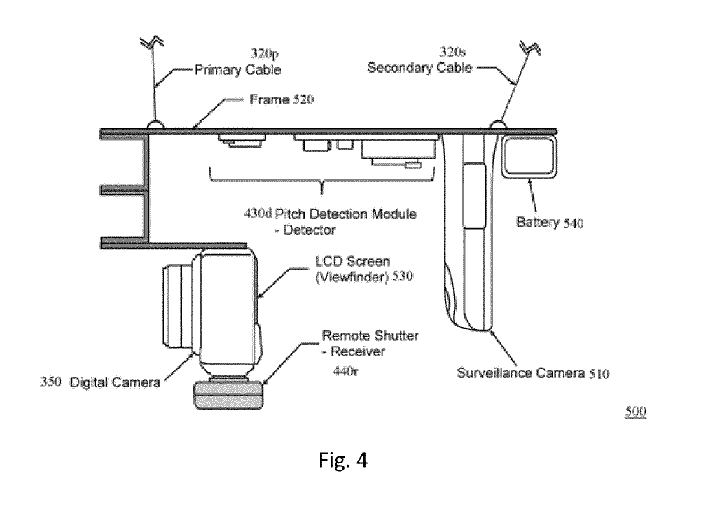

FIG. 2 is a schematic diagram which illustrates a second embodiment for the bridge inspection system in accordance with the present invention. The bridge inspection system 300 includes the mobile base 310, the dual-cable suspension medium 320 and the inspection platform 330. The controller 340, situated at a local end, is disposed on the mobile base 310, and the digital camera 350 and surveillance camera (shown in the following FIG. 4) are disposed on the inspection platform 330 situated at a remote end. The mobile base 310 is preferably a fishing rod.

The dual-cable suspension medium 320 is utilized to sustain the inspection platform 330. A fishing rod is a typical and commonly-used cable-driven device. It is an ideal and readily available option to act as the mobile base 310. But it is simply found that with only one cable, there will be a spinning degree of freedom, which is undesirable for a stable inspection. Therefore, the dual-cable mechanism was provided in this invention. With two cables, the spinning degree of freedom can be eliminated. In addition, one can easily adjust the pitch angle of the inspection platform 330 by assigning different lengths for the two cables.

The inspector 360 preferably stands beside the bridge 370 edge to operate the system 300. The controller 340 is the part carried by the inspector 360. The inspector 360 uses it to control the system 300. Next, the dual-cable suspension medium 320 is preferably a cable mechanism that hangs the inspection platform 330 under the bridge 370. The dual-cable suspension medium 320 includes the primary cable 320p and the secondary cable 320s. The primary cable 320p is close to the inspector 360, and it sustains the major weight of the inspection platform 330. The secondary cable 320s is used for eliminating the spinning degree of freedom of the inspection platform 330 and adjusting the pitch angle of the inspection platform 330. The secondary cable 320s is away from the inspector 360 and sustains less weight than the primary cable 320p. The Inspector 360 can fine tune the elevation and pitch angle of the inspection platform 330 through adjusting cable lengths. The cable-based inspection system 330 is a lightweight structure.

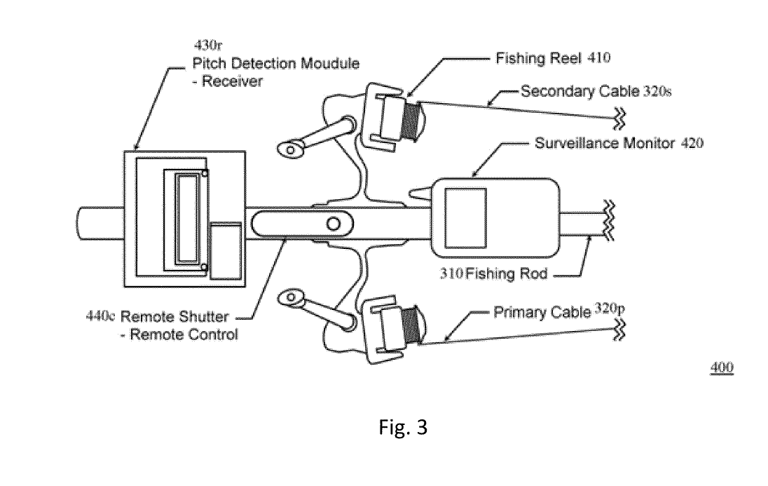

FIG. 3 is a schematic diagram which illustrates the controller in the bridge inspection system in accordance with the present invention. The controller 400 is disposed on the mobile base 310 (for example, the fishing rod) includes two fishing reels 410, the surveillance monitor 420, the pitch detection module 430 and the remote shutter 440.

The two fishing reels 410 are mounted on the rod 310 along with 10 meters high-strength cable on each reel. Inspector 360 can adjust cable length through the reels in order to fine tune the inspection platform's elevation and pitch angle. For example, if the primary cable 320p is longer, the inspection platform 330 will face downward, and if the secondary cable 320s is longer, the inspection platform 330 will face upward. If both two cables 320 are released, the inspection platform's elevation will drop, and vice versa.

In order to detect the pitch angle of the inspection platform 330, a pitch detection module 430 was developed. The pitch detection module 430 has two parts: the detector 430d disposed on the inspection platform 330 at the remote end and the receiver 430r disposed on the mobile base at the local end. The detector 430d is integrated with the inspection platform 330, as shown in FIG. 4. It sends the detected pitch angle wirelessly to the receiver 430r in the pitch detection module 430. On the other hand, the receiver 430r is integrated with the controller 340. It displays the received pitch angle on a LCD screen, helping the inspector when adjusting the suspension.

Other components further include a surveillance monitor 420, and a remote shutter 440. The surveillance monitor 420 displays what the inspection platform's digital camera 350 sees, helping the inspector when focusing the digital camera 350. When inspector wants to capture inspection image, one can push the bottom on the remote control 440c in the remote shutter 440 to capture the image.

FIG. 4 is a schematic diagram which illustrates the inspection platform in the bridge inspection system in accordance with the present invention. The inspection platform 500 is an integration of the pitch detection module detector 430d, the digital camera 350, the surveillance camera 510, and the wireless communication modules (not shown) at the remote end to wirelessly transmit the signals from the detector 430d, the cameras 350 and 510 to the receiver 430r, the remote control 440c and the surveillance monitor 420 at the local end, to provide a real-time image capturing ability. It is suspended by the dual-cable suspension, and is sent under the bridge to capture inspection images. In order to increase the inspection platform 500 stability, the center of gravity of the platform should be as low as possible. Consequently, all devices are mounted upside down. The surveillance monitor 420, which is mounted on the controller 400, is also upside down. Therefore, the inspector still see normal inspection image.

The main setup of the inspection platform 500 is shown in FIG. 4. The platform 500 includes the digital camera 350, the remote shutter receiver 440r, the surveillance camera 510, the detector 430d of pitch detection module, and supporting frame 510. The digital camera 350 is mounted on the front end of the supporting frame 510. The surveillance camera 510 is mounted behind the digital camera 350, and focuses on the digital camera's LCD screen 530, namely the viewfinder. Through the surveillance monitor 420, inspector 360 can see the real-time image of the digital camera's view. Inspector 360 can then take inspection image in proper times by using remote shutter control 440c. The detector 430d of the pitch detection module can provide platform pitch angle data. The battery 540 of the detector 430d of the pitch detection module is mounted at the rear end of the supporting frame 520. Real-time pitch angle information can help inspector 360 to adjust the inspection platform 330, 500 to desired angle.

There are further embodiments provided as follows.

Embodiment 1: a system for inspecting a bridge, includes: an image sensor; a base immobily secured to the bridge and having an actuator disposed thereon; and a suspending medium having a first and a second ends, respectively connected with the image senor and the actuator so that the actuator actuates the image sensor to motion in one of a swing mode and a spinning mode through the suspending medium.

Embodiment 2: the system according to Embodiment 1, further includes: an information processing device processing a digital data obtained and transmitted from the image sensor.

Embodiment 3: the system according to Embodiment 2, the image sensor is in wireless communication with the information processing device.

Embodiment 4: the system according to Embodiment 2, the information processing device is one selected from a group consisting of a laptop computer, a notebook computer, a personal computer, a smart phone and a combination thereof.

Embodiment 5: the system according to Embodiment 1, the image sensor is one selected from a group consisting of a digital camera, a digital video camera and a combination thereof.

Embodiment 6: the system according to Embodiment 1, the bridge has a bottom and the image sensor is used for capturing an image of the bottom.

Embodiment 7: the system according Embodiment 1, the bridge has an edge and the base is immobily secured to a position in proximity to the edge.

Embodiment 8: the system according to Embodiment 1, the suspending medium is one selected from a group consisting of a fishing line, a cable, a rope and a combination thereof.

Embodiment 9: the system according to Embodiment 1, the swing mode is a resonance frequency swing mode and the spinning mode is a merry-go-round spinning mode.

Embodiment 10: a system for inspecting a bridge, includes: a mobile base; an image sensor; and a first suspending medium and a second suspending medium, each of which has a first and a second ends respectively connected with the mobile base and the image sensor.

Embodiment 11: the system according to Embodiment 10, further includes: an information processing device processing a digital data obtained and transmitted from the image sensor.

Embodiment 12: the system according to Embodiment 11, the image sensor is in wireless communication with the information processing device.

Embodiment 13: the system according to Embodiment 11, the information processing device is one selected from a group consisting of a laptop computer, a notebook computer, a personal computer, a smart phone and a combination thereof.

Embodiment 14: the system according to Embodiment 10, the image sensor is one selected from a group consisting of a digital camera, a digital video camera and a combination thereof.

Embodiment 15: the system according to Embodiment 10, the bridge has a bottom and the image sensor is used for capturing an image of the bottom.

Embodiment 16: the system according Embodiment 10, the bridge has an edge and mobile base is immobily secured to a position in proximity to the edge.

Embodiment 17: the system according to Embodiment 10, each of the first and the second suspending medium is one selected from a group consisting of a fishing line, a cable, a rope and a combination thereof.

Embodiment 18: a method for inspecting a bridge, includes steps of: providing a base and an image sensor; and providing a first suspending medium having a first and a second ends respectively connected with the image sensor and the base so as to swing the image sensor.

Embodiment 19: the method according to Embodiment 18 further includes a step of providing a second suspending medium having a first and a second ends respectively connected with the image sensor and the base.

Embodiment 20: the method according to Embodiment 18 further includes a step of providing an information processing device to process a digital data from the image sensor.

In conclusion, the invention develops an inspection method which can help bridge inspector to complete inspection task with higher efficiency, and is suitable for under-deck inspection of middle to small bridges. Several factors are suggested to be considered in developing the system as follows. (1) Portable and fast deployment: the system requires these characteristics to enhance inspection efficiency. (2) Safe operation: all human tasks shall take place on the bridge deck, eliminating all risks from sending people under bridge. (3) Affordable price: the total price of the system should be affordable to regional government or other responsible organization.

The expected bridge inspection system is suitable for middle to small bridges. Those bridges need regular inspection but few of them need to be repaired. In brief, the new developed bridge inspection system should be designed to be portable and simple. The system can receive bridge inspection result efficiently. Further detailed inspection or repair is required only if the result shows the bridge is in a bad condition.

In this invention, wireless transmission and cloud computing are the key technologies to further increase bridge inspection efficiency. When the cable-based inspection system is integrated with these technologies, inspection images can instantly transfer to and present on an online database, and be analyzed by experienced engineers.

While the disclosure has been described in terms of what are presently considered to be the most practical and preferred embodiments, it is to be understood that the disclosure need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A system for inspecting a bridge, comprising:
an image sensor;
a base immobily secured to the bridge and having an actuator disposed thereon; and
a suspending medium having a first and a second ends, respectively connected with the image senor and the actuator so that the actuator actuates the image sensor to motion in one of a swing mode and a spinning mode through the suspending medium.

2. The system according to claim 1, further comprising:
an information processing device processing a digital data obtained and transmitted from the image sensor.

3. The system according to claim 2, wherein the image sensor is in wireless communication with the information processing device.

4. The system according to claim 2, wherein the information processing device is one selected from a group consisting of a laptop computer, a notebook computer, a personal computer, a smart phone and a combination thereof.

5. The system according to claim 1, wherein the image sensor is one selected from a group consisting of a digital camera, a digital video camera and a combination thereof.

6. The system according to claim 1, wherein the bridge has a bottom and the image sensor is used for capturing an image of the bottom.

7. The system according claim 1, wherein the bridge has an edge and the base is immobily secured to a position in proximity to the edge.

8. The system according to claim 1, wherein the suspending medium is one selected from a group consisting of a fishing line, a cable, a rope and a combination thereof.

9. The system according to claim 1, wherein the swing mode is a resonance frequency swing mode and the spinning mode is a merry-go-round spinning mode.

10. A system for inspecting a bridge, comprising:
a mobile base;
an image sensor; and
a first suspending medium and a second suspending medium, each of which has a first and a second ends respectively connected with the mobile base and the image sensor.

11. The system according to claim 10, further comprising:
an information processing device processing a digital data obtained and transmitted from the image sensor.

12. The system according to claim 11, wherein the image sensor is in wireless communication with the information processing device.

13. The system according to claim 11, wherein the information processing device is one selected from a group consisting of a laptop computer, a notebook computer, a personal computer, a smart phone and a combination thereof.

14. The system according to claim 10, wherein the image sensor is one selected from a group consisting of a digital camera, a digital video camera and a combination thereof.

15. The system according to claim 10, wherein the bridge has a bottom and the image sensor is used for capturing an image of the bottom.

16. The system according claim 10, wherein the bridge has an edge and mobile base is immobily secured to a position in proximity to the edge.

17. The system according to claim 10, wherein each of the first and the second suspending medium is one selected from a group consisting of a fishing line, a cable, a rope and a combination thereof.

18. A method for inspecting a bridge, comprising steps of:
providing a base and an image sensor; and
providing a first suspending medium having a first and a second ends respectively connected with the image sensor and the base so as to swing the image sensor.

19. The method according to claim 18 further comprising a step of providing a second suspending medium having a first and a second ends respectively connected with the image sensor and the base.

20. The method according to claim 18 further comprising a step of providing an information processing device to process a digital data from the image sensor.
